(19) United States
(12) Patent Application Publication
(10) Pub. No.: US 2025/0137318 A1
(43) Pub. Date: May 1, 2025

(54) MODULAR RAIL FOR DOOR, SYSTEMS AND METHODS

(71) Applicant: Masonite Corporation, Tampa, FL (US)

(72) Inventors: Benjamin DOCKSTEADER, Custer, WA (US); Joel SELLINGER, Blaine, WA (US)

(21) Appl. No.: 18/931,416

(22) Filed: Oct. 30, 2024

Related U.S. Application Data
(60) Provisional application No. 63/594,642, filed on Oct. 31, 2023.

(51) Int. Cl. E06B 7/18; E05F 15/63; E06B 7/02; E06B 7/28

(52) U.S. Cl. CPC E06B 7/18; E05F 15/63; E06B 7/28; E06B 2007/023

(57) ABSTRACT

A modular rail component is described, e.g., as a modular rail accessory (MRA) that is configured to enclose a plurality of modular components, with the MRA structurally constituting one of: a bottom rail or a top rail of the modular door system.

### CROSS-REFERENCE TO RELATED APPLICATIONS

This application claims the benefit of U.S. Application No. 63/594,642, filed Oct. 31, 2023, the contents of which are incorporated by reference herein in their entirety.

### FIELD OF THE INVENTION

The present invention is related generally to doors and related systems and methods including use of modular rails as part of the door, and more specifically to modular rail systems that provide smart device capabilities.

### BACKGROUND OF THE INVENTION

Doors are an essential part of every building, providing residents with access and security. Conventional smart doors disclose fixation of devices and features within various sections of a door. As devices and features need to be installed into respective sections of the door, each individual section of the door requires a specific design to accommodate the devices and features, thereby making device installation and door manufacturing process difficult. Moreover, it may also be difficult to transport and assemble such individual sections of the door.

Further, connectivity and functionality needs are likely to change frequently depending on location, preferences, emerging/developing technologies, and other factors. Additionally, such components of the door may have a limited lifetime expectancy compared to the door itself and require frequent inspection, upgradation, and replacement. However, access to the individual sections or components of a door is limited and maintenance of such components may require extensive manual effort, time, and cost. Moreover, the entire door assembly may have to be removed and/or disassembled for replacement and upgradation of individual components.

What is needed in the art are doors, systems and methods that minimize expenses to accommodate such components of the door in a cost-effective manner, with optimized expenses associated with, for example, a manufacturing process to accommodate such components of the door, a transportation cost, a maintenance cost and/or a replacement cost associated with such components of the door.

### SUMMARY

The present disclosure overcomes the disadvantages of the art by providing a modular rail component that encloses at least one, and in exemplary aspects, a plurality of components configured to provide smart home or a smart building functionality.

In exemplary aspects, the modular rail component is provided as a modular rail accessory (“MRA”), that is configured to add to an existing door.

In further exemplary aspects, the modular rail component functions as a single modular assembly of a door that encloses multiple components (for example, with distinct features) required for a modular door system in entirety in a single door section or location.

In an exemplary embodiment, a modular rail component is configured such that it structurally constitutes either a bottom rail portion of the door or a top rail portion of the door. In other exemplary aspects, a modular rail component is configured to constitute a side portion of the door. In either case, the width or height of the modular rail accessory may vary, e.g., constituting 5 percent of the door space, 10 percent of the door space, 15 percent of the door space, etc. Additionally, in exemplary aspects the modular rail component may extend up to 50 percent across the width or height of the door, or up to 40 percent, up to 30 percent, up to 20 percent, up to 10 percent, up to 5 percent, up to 3 percent, or up to any percentage therein.

In further exemplary aspects, a MRA sub assembly is attached to a hollow area of a door slab of an existing door at the bottom rail or the top rail location to achieve the final size of the door. In an exemplary embodiment, the MRA can be assembled to the existing door manufactured by conventional production methods by trimming the existing door to accommodate the MRA. The MRA is configured if required and then installed into the door to achieve the features needed and final size of the door. The MRA equipped door can be installed to a door location using conventional installation methods.

Other aspects of the invention, including devices, systems, methods and the like which constitute part of the invention, will become more apparent upon reading the following detailed description of various exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1A is a perspective view of an exemplary modular rail assembly provided at the bottom of an exemplary door slab;

FIG. 1B is a perspective cutout view of the exemplary modular rail assembly of FIG. 1A;

FIG. 2A is a perspective view of an exemplary slidable and removable modular rail assembly;

FIG. 2B is a perspective cutout view of the exemplary modular rail assembly of FIG. 2A;

FIG. 3A is perspective view of another exemplary modular rail assembly; and

FIG. 3B is a perspective cutout view of the exemplary modular rail assembly of FIG. 3A.

### DETAILED DESCRIPTION OF EXEMPLARY EMBODIMENTS

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “vertically,” “downwardly,” “upwardly,” etc.) should be construed to refer to the orientation as then described or as shown in the drawing figure under discussion and to the orientation relative to a vehicle body. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. Additionally, the word “a” and “an” as used in the claims means “at least one” and the word “two” as used in the claims means “at least two”.

As we have noted, the present disclosure describes a modular rail component that encloses at least one, and in exemplary aspects, a plurality of components configured to provide smart home or a smart building functionality.

In exemplary aspects, the modular rail component is provided as a modular rail accessory (“MRA”), that is configured to add to an existing door.

In further exemplary aspects, the modular rail component functions as a single modular assembly of a door that encloses multiple components (for example, with distinct features) required for a modular door system in entirety in a single door section or location.

In an exemplary embodiment, a modular rail component is configured such that it structurally constitutes either a bottom rail portion of the door or a top rail portion of the door. In other exemplary aspects, a modular rail component is configured to constitute a side portion of the door. In either case, the width or height of the modular rail accessory may vary, e.g., constituting 5 percent of the door space, 10 percent of the door space, 15 percent of the door space, etc. Additionally, in exemplary aspects the modular rail component may extend up to 50 percent across the width or height of the door, or up to 40 percent, up to 30 percent, up to 20 percent, up to 10 percent, up to 5 percent, up to 3 percent, or up to any percentage therein.

In an exemplary aspect, the modular rail has a width or height dimension (height for bottom or top of the door, width for an edge of the door) of between 1 and 6 inches. In other exemplary embodiments, the modular rail is sized according to the components housed therein, e.g., where an open assist device has a motor that has a 2-inch dimensional profile, the modular rail is greater than 2 inches, but less than, e.g., 5 or 4 or 3 inches. Similarly, where one or more fans are housed in the modular rail, the height or width of the rail may account for fan sizes from e.g., 2 to 5 or 6 inches, and be greater than such sizes, but only by an extra inch, 2 inches, etc. In exemplary embodiments where the modular rail contains, e.g., a processor, sensors and lights without larger profile devices, such modular rail may have a width or height of e.g., one inch, or indeed may have such a width and be cut into a portion of the door (be it a bottom, top or side portion), and externally present a viewable width or height of less than one inch. Further, the modular rail can run the entire length of whatever side the modular rail is on (top, bottom or side) or only over a portion of such length, e.g,, where a side portion is cut out for a foot or two only, and the modular rail is attached to, slid over, etc., that portion during installation, removal, reinstallation, etc.

In further exemplary aspects, a modular rail sub assembly is attached to a hollow area of a door slab of an existing door at the bottom rail or the top rail location to achieve the final size of the door. In an exemplary embodiment, the MRA can be assembled to the existing door manufactured by conventional production methods by trimming the existing door to accommodate the modular rail. The modular rail is configured if required and then installed into the door to achieve the features needed and final size of the door. The modular rail equipped door can be installed to a door location using conventional installation methods.

In one exemplary embodiment, the modular rail is configured as a single piece MRA or a multi-piece MRA. An exemplary single-piece MRA is permanently affixed to the door slab and allows components to be swapped in and out of the MRA sub assembly as and when needed. In another exemplary embodiment, the multi-piece MRA is configured such that the entire MRA sub assembly can be removed as a single unit for replacement, upgrades, or to facilitate charging. The multi-piece MRA includes a slide rail structure, or a similar mechanism permanently attached to the door slab. In one instance, the slide rail structure includes a slide mount that engages with the MRA sub assembly and dowel pins (or other securing element(s)) to secure the MRA sub assembly in place. The MRA sub assembly can be completely detached when the dowel pins are removed and the MRA sub assembly is slid off the door. The multi-piece MRA is advantageous in terms of interchangeability of individual devices and replaceability/upgradation of the entire MRA sub assembly as a single unit.

In exemplary aspects, the modular rail houses various electronic components, mechanical components, sensors, and batteries within the modular rail. Exemplary components and devices include, without limitation, one or more vent fans, an air bladder, LEDs, a battery area, a PCBA, a processor, a swing arm coupled to a motor, motion sensors, one or more USB connection ports, a power latch, etc. The MRA sub assembly allows all the components and devices to be enclosed within a single enclosure or compartment of the MRA without the need to modify the existing door structure.

An exemplary modular rail equipped door is capable of being controlled and used by a homeowner using remote applications, remote control devices, or physical inputs and adjustments on the MRA. In exemplary embodiments, the modular rail effectively houses all the components, devices, and features for smart home and smart door functionality within the MRA that forms the door rail structure provides material and cost savings, easy assembly of modular door components within a door, simple transportation, better usability, and flexibility. This can also include processors, wifi or other data exchange modules, wireless power modules, magnetic puck or other external battery charge connections, status lights, cameras, sensors, displays, user interfaces, identification, authentication, authorization, security, or other access control or security features, etc., such as may be placed in a smart door.

In exemplary aspects described herein, a modular door system includes a modular rail accessory (MRA) configured as a single assembly to enclose a plurality of modular components. The MRA structurally constitutes (in this exemplary embodiment) a bottom rail or a top rail of the modular door system. The MRA is attachable to a hollow area of a door slab of an existing door that is trimmed to accommodate the MRA. A single enclosure or housing of the MRA encloses the plurality of modular components in entirety. In one exemplary aspect, the MRA is a multi-piece MRA that includes an MRA sub assembly to enclose the plurality of modular components, a slide mount, and dowel pins (or other connection device). The slide mount slidably attaches to the door slab and engages with the MRA sub assembly. The MRA sub assembly detaches from the door slab when the dowel pins are removed and the MRA sub assembly is slid off from the modular door system. The configuration of the multi-piece MRA allows upgradation and replacement of the MRA as a single unit.

In another exemplary aspect, the MRA is a single piece MRA that is permanently fixed to the modular door system and allows the plurality of modular components to be swapped in and out. The MRA in accordance with aspects described herein overcomes the problems associated with smart door manufacturing, cost, transportation, maintenance, and replacement, thereby achieving a modular door system with better modularity, usability, and operability.

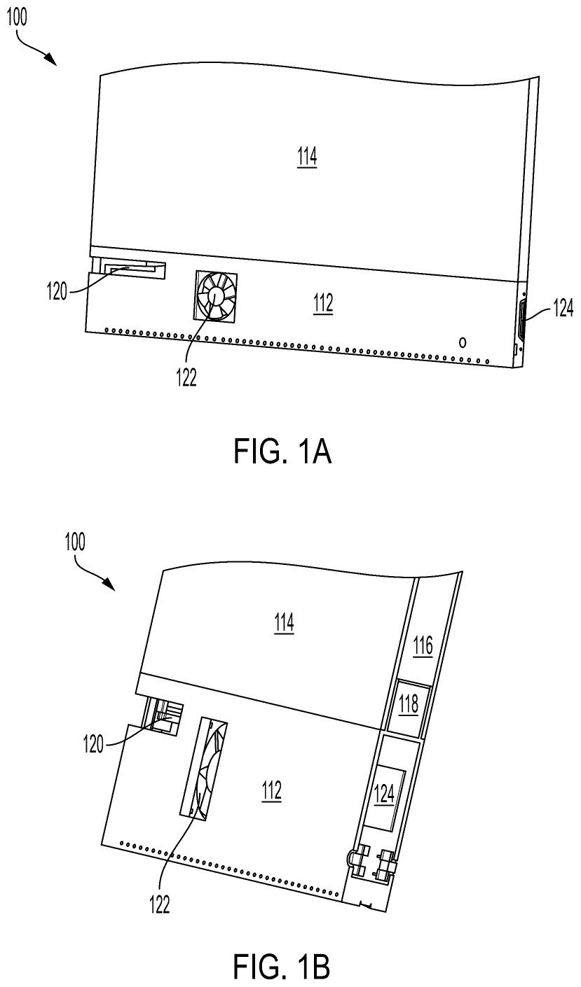

FIGS. 1A and 1B depict an exemplary modular rail accessory (MRA) 112 attached to a door slab 114, the combination of which is shown generally at 100. In exemplary aspects, the MRA functions as a single exclusive housing for a plurality of components and features that attribute to a modular door system for smart home or home automation functionalities. The MRA facilitates co-location of one or more electronic components, sensors, mechanical components, and batteries for independent or connected functionality.

In one exemplary embodiment of the present disclosure, the MRA is configured as a modular rail that is attachable to the modular door system. In additional exemplary embodiments, the MRA structurally forms a bottom rail, which is the bottommost portion of a door. In another exemplary embodiment, the MRA structurally forms a top rail which is the topmost portion of the door. The MRA allows accommodation of the plurality of components and features of the modular door system in entirety within a single location of the door at the top rail or at the bottom rail of the door (or on a side rail, pocket as a portion of a side of the door or a portion of a cavity at least partially within the door (e.g., at least partially within a hollow inside any portion of the door, such as a hollow between two door skins, a hollowed out portion of the door, etc., thereby excluding the need for installation of the devices or components at multiple locations of the door.

As shown in the exemplary embodiment illustrated in FIGS. 1A and 1B, MRA sub assembly is attached to a door slab at the bottom position of the modular door system. In an exemplary embodiment, e.g., as is shown in FIG. 1B, the MRA 112 is configured to be attached, e.g., via extended rail portions 118 to a hollow area section 116 on the door slab 114. Specifically, the MRA is attached to the hollow area section 116 formed on a side surface of a lower section of the door slab. It should also be noted that various attachment mechanisms are contemplated herein, e.g., with a complementary contour that allows sliding installation of the rail into a complementary portion in the door, with an extended rail contour that fits within a hollow in the slab (as is shown in FIGS. 1A and 1B), via pins, grommets, magnets, etc., or otherwise.

We also note that FIGS. 1A and 1B show just some of the exemplary possible components for the modular rail, including an open assist device 120, a fan 122, and a battery compartment 124, which can be configured to house a rechargeable battery.

In exemplary embodiments, the MRA is attached to an existing door manufactured using conventional high volume production processes. The MRA sub assembly is configured such that it has suitable dimensions that would easily meet the fitting requirements of an already existing door and conventional door sizes. More specifically, the MRA can be fixed to the existing door without the need for replacement of remaining parts of the existing door. Existing doors produced by any of the conventional door manufacturing processes can be trimmed to accommodate the MRA and meet the required final size of the door. In one embodiment, a lower section of the existing door is trimmed to accommodate the MRA in the bottom rail location of the door. In an alternate embodiment (or where plural MRA components, e.g., lower and upper modular rail components, are desired), an upper section of the existing door is trimmed (or a hollow made) to accommodate the MRA in the top rail location of the door. The MRA can thus be assembled and fitted with minimal exercise to the existing door manufactured using existing equipment, tools, and methodologies. In exemplary aspects described herein, the MRA can also be configured as per requirements and installed into the existing door to achieve features needed and the final size of the door. In addition, the MRA equipped door can be installed into a door location using same installation methods as that of the conventional doors without any additional exercise. Furthermore, the MRA sub assembly is also flexible enough to be removed and replaced with any of the other existing doors within the building or elsewhere.

In an exemplary embodiment, the MRA is a single piece MRA that is permanently fixed to the door slab and forms an integral part of the modular door system. In one aspect of the exemplary embodiment, the MRA is permanently affixed to the structural bottom rail portion of the door slab of the modular door system. In another aspect of the exemplary embodiment, the MRA is permanently affixed to the structural top rail portion of the door slab of the modular door system. The single piece MRA is configured to allow access to individual components and features embedded within the MRA sub assembly. The MRA allows inspection, adjustment, reparation, and replacement of the plurality of components with ease. For example, the MRA allows swapping of peripherals in and out of the MRA, upgrade of processors, memory, sensors, communications hardware, mechanical hardware, or other components, etc., as needed without the need to remove the MRA sub assembly and the door skins or surfaces.

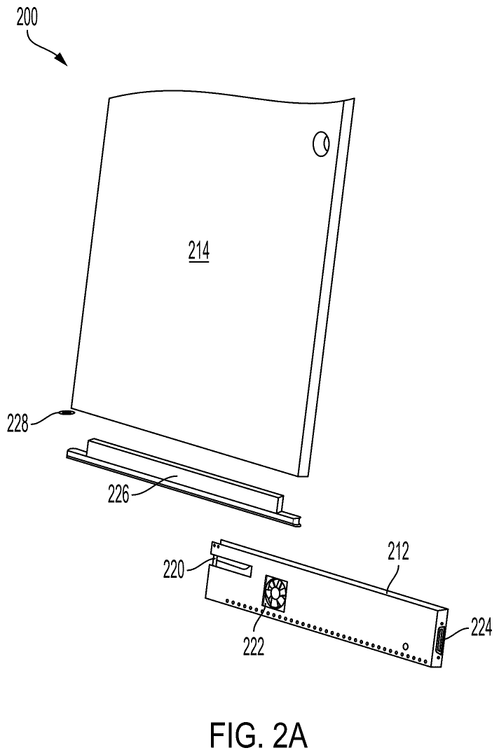

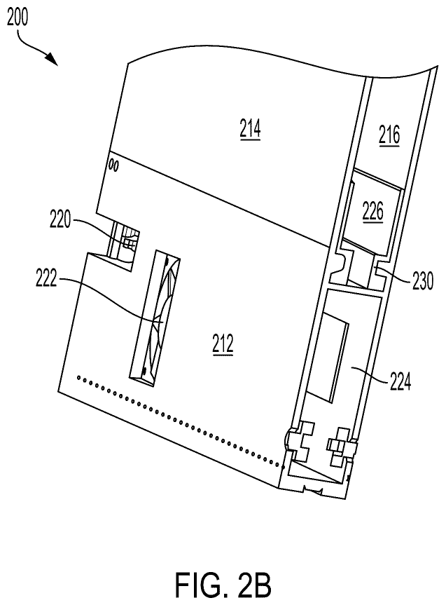

In another exemplary embodiment of the present disclosure, the MRA is designed and configured as a multi-piece MRA. As shown in FIGS. 2A and 2B, an exemplary multi-piece MRA 212 is configured as a slidable and removable rail structure on the modular door system. The multi-piece MRA facilitates the MRA sub assembly to be removed as a single unit from the modular door system as and when required. In accordance with an embodiment, the multi-piece MRA includes a slide rail 226 or a similar structure that may be permanently fixed (though the present specification does contemplate non-permanent fixture of such a slide rail embodiment) to the hollow interior portion 216 of the door slab 214. The exemplary slide rail structure enables the MRA sub assembly to be mounted on the door in a manner that it can be readily removed and replaced, and may include quick connect and disconnect aspects, e.g., by a button depression to unlock a slide rail catch, or via other attachment mechanisms.

In an exemplary embodiment, the multi-piece MRA includes the MRA sub assembly constituting the top rail or the bottom rail of the door, a slide mount 226 attached to the door slab, and dowel pins 228 or a similar structure securing the MRA sub assembly in place. The slide mount and dowel pins along with the MRA sub assembly constitute the multi-piece MRA. The exemplary illustrated slide mount is permanently fixed to the door slab and forms an interlocking mechanism 230 to engage with the detachable MRA sub assembly. The slide mount engages with the MRA sub assembly in the hollow interior portion of the door slab. The dowel pins when pushed enable the MRA sub assembly to be secured tightly to the modular door system. The dowel pins can be removed and the MRA sub assembly can be slid along the slide mount to remove the MRA sub assembly as a single unit. The slide mount system facilitates easy replacement and alteration of the MRA sub assembly when the user desires to upgrade the features of the MRA sub assembly. For example, the entire feature package of the MRA can be upgraded by replacing the entire modular rail structure. In another example, individual devices or components embedded in the MRA sub assembly can be easily swapped with a new device or component as the lifetime expectancy of electronic devices or components are usually limited. In another example, the MRA can be removed to facilitate charging of one or more individual components embedded in the MRA sub assembly. Additionally, the slide mechanism of the multi-piece MRA also facilitates the MRA to be assembled and fixed to the modular door by a novice or a general user.

The illustrated exemplary embodiments shown in FIGS. 2A and 2B also show an assisted opening device 220, a fan 222 and a battery compartment 224, though more or other components may be included.

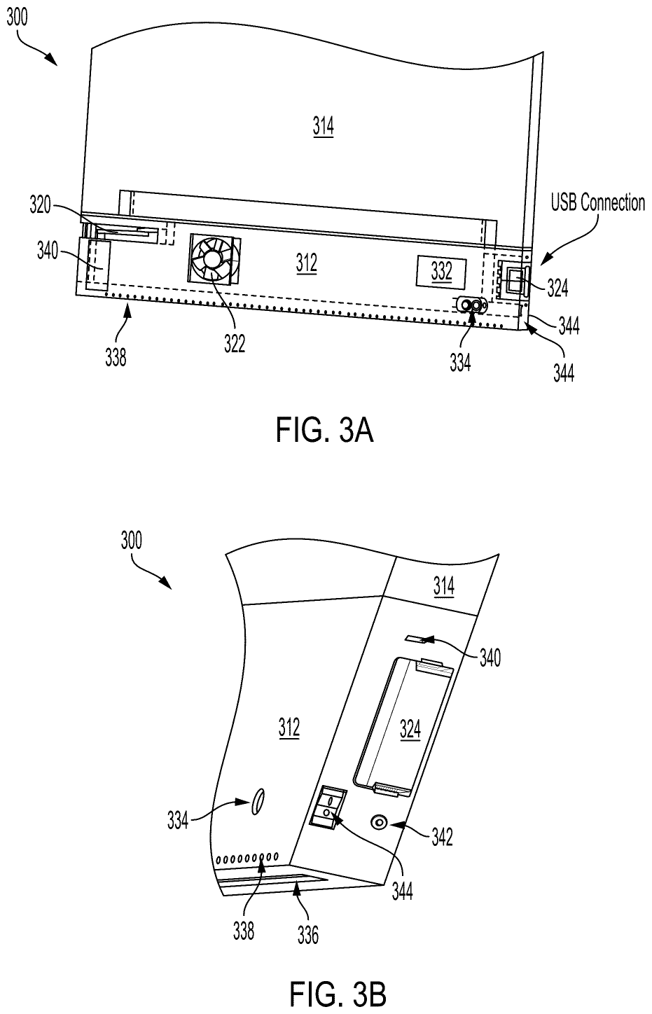

FIGS. 3A and 3B depict, generally at 300, an exemplary modular rail 312, connected to a slab 314, with an arrangement of a plurality of components including an opening assist 320 and fan 322, as in FIGS. 1A-2B, with additional various electronic components, mechanical components, and sensors within the MRA. As illustrated in FIG. 3A, the MRA 312 includes an enclosure or compartment or housing within which all the plurality of components and devices of the modular door system are arranged in a suitable manner. In an exemplary embodiment, the devices and components are lined up and arranged along a single MRA housing. Providing multiple components within the single enclosure of the modular rail averts the need for modifying the internal and/or external door structure to accommodate multiple devices. For example, enclosing all the plurality of components within a single housing avoids the need to create a separate enclosure or space or cavity or opening within a door structure for each component as in the conventional methods.

The illustrated exemplary MRA housing includes a variety of electromechanical features, sensors, and devices. In one exemplary aspect, the MRA housing includes a vent fan 322 or an air movement fan to control air flow in and out of the room. In another exemplary aspect, the MRA housing includes an airbladder or a similar elastic element (not shown) that temporarily expands to seal against the jamb and/or floor to limit light and noise from passing under the door from adjacent spaces.

In another exemplary aspect, the MRA housing includes a circuitry. The circuitry includes, e.g., a processor, suitable logic, circuitry, and interfaces that may be configured to execute program instructions associated with different operations to be executed by the modular door system. For example, a PCBA (printed circuit board) 332 is shown in phantom within the modular rail 312 in FIG. 3A. That circuit board can be connected to a larger system or a provider, e.g., by a radio, wifi or other communication mechanism (whether it be wired or wireless).

The circuitry may be implemented based on various processor technologies known in the art. Examples of implementations of the circuitry may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits. In one example embodiment, the circuitry is a Printed Circuit Board Assembly (PCBA) with connectivity radio, microprocessor, and associated EE controls.

In another exemplary aspect, the MRA housing includes motion sensors with light/dark sensors 334. The light/dark sensors can be PCBA mounted sensors or independent sensors and outward facing sensors or inward facing sensors. In yet another exemplary aspect, as depicted in FIGS. 3A and 3B, the MRA housing includes one or more LEDs. The type of LEDs is not limited and can include one or more of downward facing LEDs 336, inward facing LEDs (not shown), outward facing LEDs 338, etc.

In yet another exemplary embodiment, the MRA housing includes a swing arm 320 as depicted in FIG. 3A. The swing arm is configured to swing the door open and close by means of a roller wheel or a similar mechanism. In one instance, the swing arm swings inward to contract the door jamb and drive the door open. In another instance, the swing arm swings outward to contract the door jamb and drive the door to be closed. The swing arm is coupled to a motor 340 as shown in FIG. 3A for driving the opening and closing motion of the door.

In one exemplary embodiment, as shown above in FIGS. 3A and 3B, the MRA housing includes a battery area 324. In exemplary embodiments, the battery area includes an insertable and removeable battery tray for mounting a battery. The battery tray is insertable into a hollow interior portion of the MRA sub assembly. For instance, as depicted in FIGS. 3A and 3B above, the battery tray can be inserted into the hollow interior portion via an opening on a side surface of the MRA sub assembly. The battery tray is slidable and detachable from the hollow interior portion for battery insertion or replacement. As an alternative embodiment, the battery can be inserted into the MRA sub assembly directly. The battery may be a source of electric power for the circuitry or one or more electric circuits (not shown). The battery may be a rechargeable battery. Examples of the battery may include, but are not limited to, a lead acid battery, a nickel cadmium battery, a nickel-metal hydride battery, a lithium-ion battery, and other rechargeable batteries.

In another exemplary embodiment, the MRA housing includes a control area that consists of a USB connection port 340, a connection/multi-function button 342, and a system power button 344. The system power button functions as a master switch or a power latch to unlatch, open, and close the door. As shown in FIGS. 3A and 3B, the control area is positioned on a side surface of the modular rail structure. In one aspect of the embodiment as described herein, the components of the control area and the battery area are positioned adjacent to each other on the same side surface of the MRA sub assembly for better usability.

The MRA sub assembly allows each of the plurality of components to be swapped in and out of the MRA with flexibility and ease. Providing the plurality of components within the rail structure of the door allows better usability and flexibility. Particularly, providing the plurality of components in the bottom rail of the door provides easy operability and access to the components as and when required. The user as and when desires can inspect, modify, or replace the features by accessing the MRA sub assembly forming the rail structure of the door. For instance, the MRA housing allows swapping of the circuitry to enable different wireless communication protocols that include, but not limited to, Zigbee, Zwave, Wifi, BLE, matter, thread, etc. In another instance, the MRA housing allows swapping of light sensors to output different lighting modes such as night light, directional light etc. In yet another instance, the MRA housing allows swapping of LEDs to output different lighting effects, cool vs warm light, RGB vs white, etc. In an alternate example, the MRA can be upgraded as a single unit by detachment of the MRA sub assembly constituting the rail structure of the door.

In exemplary embodiments, the one or more plurality of components or devices of the MRA equipped modular door system is remotely controlled and accessed by a user via remote application(s) or remote-control device(s). For example, the remote application(s) or the remote-control device(s) communicate with the modular door system through a communication network. The communication network may include a communication medium through which the plurality of components of the modular door system in a network environment may communicate with each other. The communication network may be one of a wired connection or a wireless connection Examples of the communication network may include, but are not limited to, the Internet, a cloud network, Cellular or Wireless Mobile Network (such as Long-Term Evolution and 5G New Radio), a Wireless Fidelity (Wi-Fi) network, a Personal Area Network (PAN), a Local Area Network (LAN), or a Metropolitan Area Network (MAN). The plurality of components in the network environment may be configured to connect to the communication network in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. The remote-control device may include suitable logic, circuitry, and interfaces that may be configured to transmit and receive data with the modular door system. The remote-control device may be further configured to control operation of one or more of the plurality of components. Examples of the remote-control device may include, but are not limited to, a computing device, a smartphone, a cellular phone, a mobile phone, a gaming device, a mainframe machine, a server, a computer workstation, and/or a consumer electronic (CE) device.

In another exemplary embodiment, the MRA equipped door is manually accessed and controlled by direct physical inputs and adjustments on the plurality of components on the MRA.

In accordance with exemplary aspects described herein, the present disclosure advantageously provides a cost-effective option for smart door technology. For example, exemplary aspects advantageously provide A single modular assembly either at the top rail or the bottom rail of the modular door system provides the capability to accommodate all the modular components required for a smart home functionality in entirety at a single location of a door, thereby achieving the smart home functionality with ease. Further exemplary aspects provide all the modular components within a single enclosure of a specific part of the door accomplishes material savings in modular door manufacturing and reduces substantial cost involved in the conventional smart door manufacturing processes. Additional exemplary aspects provide a solution where all the individual components of a modular door system can be assembled with ease at the same time, at a single location, and within a single module of a door. Exemplary aspects facilitate easy swapping, installation, and uninstallation of devices, peripherals, and/or components for upgrades or changes within a single modular rail structure of the door.

Further exemplary aspects provide for easy disassembly and interchangeability/replaceability of the entire modular assembly for upgradation, changes, or for charging by means of a slide mechanism that allows removal of the modular assembly as a single unit. Further, the exemplary slide mechanism of the modular rail accessory also allows interchangeability of the modular components or the modular sub assembly alone without the need to replace or modify the remaining sections of the door.

Further, in exemplary aspects, as the modular rail is manufactured as a single assembly to meet dimensions of existing door sizes, it can be fitted or assembled to the existing doors irrespective of the type, size, and method of manufacturing of the door with minimal effort. Exemplary modular rails effectively accommodate all the modular components of a door in minimal space and thereby facilitates easy transportation. Additionally, housing the components at a single location of a door also helps to achieve better usability and flexibility.

The foregoing description of the exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A modular door system, comprising:
a modular rail accessory (MRA) configured to enclose a plurality of modular components, wherein,
the MRA structurally constitutes one of: at least a portion of a bottom rail, top rail or side rail of a door slab of the modular door system.

2. The modular door system according to claim 1, wherein,
the MRA is attachable to a door slab of the modular door system,
the door slab is trimmed at one of a bottom section or a top section to accommodate the MRA, and
the MRA and the door slab constitute a final size of the modular door system.

3. The modular door system according to claim 2, wherein the MRA is attached to a hollow area of the door slab.

4. The modular door system according to claim 1, wherein the MRA includes a single housing configured to enclose the plurality of modular components in entirety.

5. The modular door system according to claim 1, wherein the MRA corresponds to a single assembly configured to enclose the plurality of modular components of the modular door system in entirety.

6. The modular door system according to claim 2, wherein the MRA is detachable as a single unit from the door slab.

7. The modular door system according to claim 6, wherein
the MRA is a multi-piece MRA that includes an MRA sub assembly, a slide mount, and dowel pins,
the slide mount is slidably attached to the door slab of the modular door system and is configured to engage the MRA sub assembly, and
the MRA sub assembly is detached from the door slab when the dowel pins are removed and the MRA sub assembly is slid off from the modular door system.

8. The modular door system according to claim 7, wherein
the slide mount is attached to a hollow interior portion of the door slab, and
the slide mount engages with the MRA sub assembly in the hollow interior portion.

9. The modular door system according to claim 2, wherein
the MRA is a single piece MRA that is permanently fixed to the door slab of the modular door system, and
the plurality of modular components is removeable and replaceable from the single piece MRA.

10. The modular door system according to claim 1, wherein the plurality of modular components includes at least one of an electronic component, a mechanical device, a sensor, or a battery.

11. The modular door system according to claim 1, wherein
the MRA enables at least one of smart home functionality or smart door functionality, and
the plurality of modular components of the MRA is controlled via at least one of a remote application, a remote-control device, or a physical input.

12. The modular door system according to claim 10, wherein
the battery is mountable on a battery tray,
the battery tray is insertable into a hollow interior portion of the MRA via an opening on a side surface of the top rail or the bottom rail, and
the battery tray is at least one of slidable or detachable from the hollow interior portion.

13. The modular door system according to claim 10, wherein the plurality of modular components includes at least one of
an elastic element to seal against a jamb of the modular door system,
a vent fan to manage air flow,
a swing arm to contract the jamb and drive the modular door system open and close,
one or more LEDs to produce different lighting,
a Printed Circuit Board Assembly (PCBA),
one or more motion sensors, or
one or more light sensors.

14. The modular door system according to claim 13, wherein the plurality of modular components is removeable and replaceable from the MRA.

15. The modular door system according to claim 10, wherein
the MRA includes a control area that includes at least one of
a power latch to open and close the modular door system,
a USB connection port, and
a connection or multifunction push button, and
the control area is positioned on a side surface of the MRA.

16. The modular rail system in accordance with claim 1, wherein the modular rail is sized according to the components contained therein.

17. The modular rail system in accordance with claim 16, wherein the components are contained in the modular rail include lights and sensors having a dimension of less than about one inch, with a dimension of the modular rail being one inch or less.

18. The modular rail system in accordance with claim 16, wherein the components are contained in the modular rail include a fan and open assist arm and motor having a dimension of less than about three inches, with a dimension of the modular rail being four inches or less.

19. The modular rail system in accordance with claim 16, wherein the components are contained in the modular rail include a fan and open assist arm and motor having a dimension of less than about five inches, with a dimension of the modular rail being six inches or less.

20. The modular rail system in accordance with claim 16, wherein the components are contained in the modular rail include a fan and open assist arm and motor having a dimension of less than about six inches with a dimension of the modular rail being six inches or less, but with a portion of the modular rail being in a hollow within the door slab, resulting in less than the six inch dimension being visible when installed into the door slab.
